(19) United States
(12) Patent Application Publication
(10) Pub. No.: US 2010/0219196 A1
(43) Pub. Date: Sep. 2, 2010

(54) Portable Pet Water Bowl Tote

(76) Inventor: Joseph Alvino, Laguna Woods, CA (US)

Correspondence Address: STEINS & ASSOCIATES, 2333 CAMINO DEL RIO SOUTH, SUITE 120, SAN DIEGO, CA, 92108, US

(21) Appl. No.: 12/396,042

(22) Filed: Mar. 2, 2009

(51) Int. Cl. B65D 51/04; A01K 7/00

(52) U.S. Cl. 220/810; 119/72

(57) ABSTRACT

A Portable Pet Water Bowl Tote. The bowl and assembly provides a pet owner with a portable source for water that also functions as the pet's drinking bowl. The tote has a carrying strap that will allow the device to be comfortably carried over the owner's shoulder or alternatively strapped around their waist. The container has a hinged lid that can be closed to seal against the rim of the bowl portion of the container in order to provide a water-tight water reservoir. The lid has a fill throat and cap so that the reservoir can be filled (or emptied) without opening the lid. Finally, a variety of pouches or pockets may be dispersed on the outer face of the lid so that the user has convenient storage locations for snacks, bags or other items.

### BACKGROUND OF THE INVENTION

1. Field of the Invention

This invention relates generally to pet care accessories and, more specifically, to a Portable Pet Water Bowl Tote.

2. Description of Related Art

A crucial part of the responsibility in owning a dog involves the regular exercising of the pet, typically in an outdoor park-like environment. In order to prolong the life of the pet, regular exercise is required which, of course, frequently involves physical exertion that can sometimes lead to pet dehydration

While the pet owner can many times carry a number of items such as balls and water bottles and bags, there has been no other single device that allows the user to carry a water bowl for the dog as well as that dog's water and other accessories or items that would be useful when exercising the pet at a location that is remote from the owner's residence.

### SUMMARY OF THE INVENTION

In light of the aforementioned problems associated with the prior devices, it is an object of the present invention to provide a Portable Pet Water Bowl Tote. The bowl and assembly should provide a pet owner with a portable source for water that also functions as the pet's drinking bowl. The tote should have a carrying strap that will allow the device to be comfortably carried over the owner's shoulder or strapped around their waist. The container should have a hinged lid that can be closed to seal against the rim of the bowl portion of the container in order to provide a water-tight water reservoir. The lid should have a fill throat and cap so that the reservoir can be filled (or emptied) without opening the lid. Finally, a variety of pouches or pockets may be dispersed on the outer face of the lid so that the user has convenient storage locations for snacks, bags or other items.

### BRIEF DESCRIPTION OF THE DRAWINGS

The objects and features of the present invention, which are believed to be novel, are set fort with particularity in the appended claims. The present invention, both as to its organization and manner of operation, together with further objects and advantages, may best be understood by reference to the following description, taken in connection with the accompanying drawings, of which:

FIG. 1 is a perspective view of a preferred embodiment of the water bowl tote of the present invention;

FIG. 2 is a perspective view of the tote of FIG. 1, showing the lid open to expose the reservoir;

FIG. 3 is a side perspective view of the tote of FIGS. 1 and 2 having a shoulder strap attached thereto;

FIG. 4 is a partial cutaway side view of the tote of FIGS. 1 through 3; and

FIG. 5 is a second partial cutaway side view of the tote of FIGS. I through 4.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Portable Pet Water Bowl Tote.

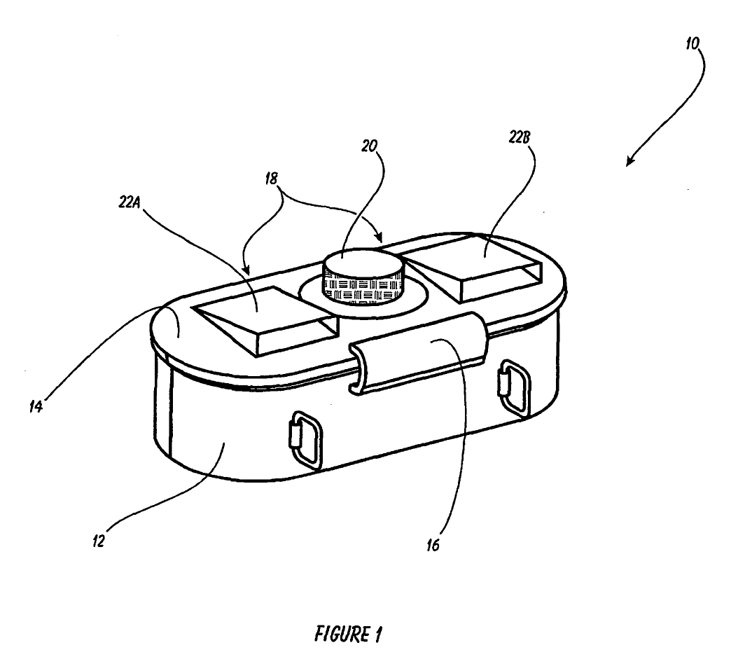

The present invention can best be understood by initial consideration of FIG. 1. FIG. 1 is a perspective view of a preferred embodiment of the water bowl tote of the present invention. The water bowl tote (10) is a device that is approximately the size of a standard dog dish. What is unique, however, is that the dish has a lid that seals closed so that the bowl can be held sideways without losing water that's being held within. The tote (10) has a body (12) that can be a variety of shapes and is not restricted to the oval shape shown in this embodiment. A lid (14) is attached to the body (12) by one or more hinges (18) along one side. The hinges (18) allow the lid to be swung open when the latch assembly (16) is released. When the lid (14) is sealed to the body (12), the user can remove the fill cap (20) and fill the interior volume of the tote (10) with water. In this embodiment there are also a pair of pockets (22a and 22b) located on the outer face of the lid (14).

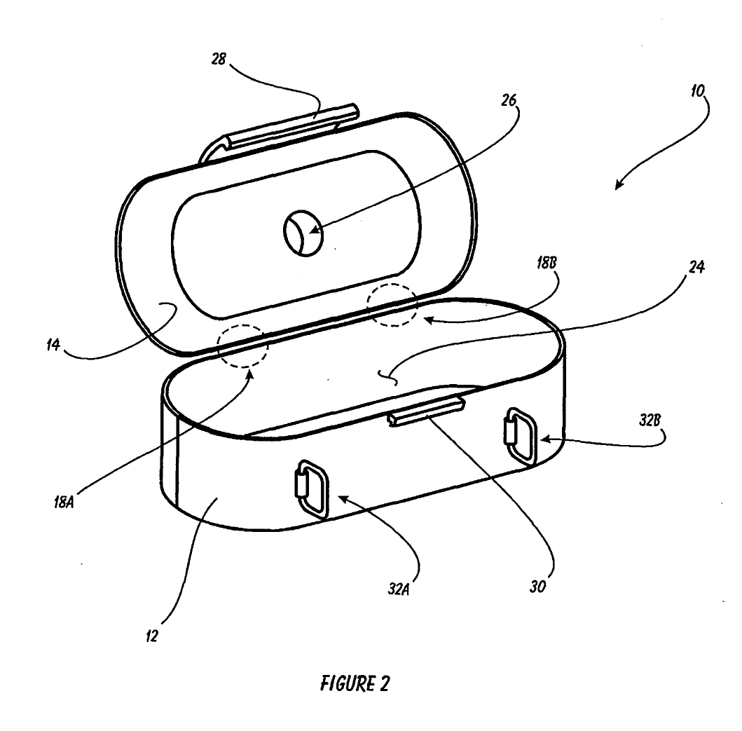

If we now turn to FIG. 2, we can further examine the details of his unique device. FIG. 2 is a perspective view of the tote of FIG. 1, showing the lid open to expose the reservoir. With the lid (14) open, we can see that the body (12) has a hollow interior or a reservoir (24). The body (12) further has a pair of strap loops (32a and 32b), the purpose for which will be discussed in more detail below. The fill throat (26) is a tubular extension from the lid (14) that allows the reservoir (24) to be filled with water when the lid (14) has been sealed against the body (12) through engagement of the latch (28) with the latch tab (30). The elements of this tote (10) are preferably made from a durable, non-corrosive material in any place where water will come in contact with those elements. Molded plastic is a particularly suitable material; however, other construction methods and construction materials might be employed.

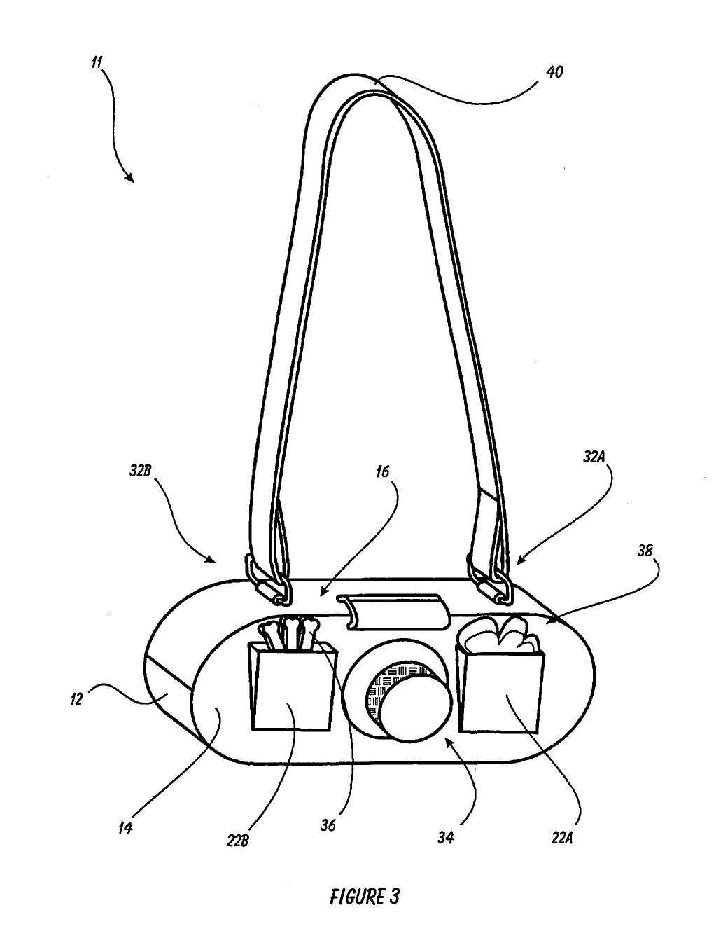

We will now turn to FIG. 3 to examine the other useful aspects of this device. FIG. 3 is a side perspective view of the tote FIGS. 1 and 2 having a shoulder strap attached thereto. The water bowl tote assembly (11) is simply the water bowl tote discussed above in connection with FIGS. 1 and 2, further including a shoulder strap (40) that is attached to the strap loops (32a and 32b). The shoulder strap allows the user to hang the strap (40) over their shoulder and thereby have the tote (10) swinging at approximately waist level or other level along the person's side by adjusting the length of the shoulder strap (40). Alternatively, the strap (40) length can be adjusted so that it can be used as a belt, and the tote (10) can be worn around the user's waist. In such a version, one or both of the ends of the strap (40) would be detachable from the strap loops (32a, 32b).

As can be seen here, the lid (14) is securely sealed against the body (12) to create a sealed case-like structure. On the outer surface of the lid (14), the first and second pockets (22a and 22b) are particularly useful for holding plastic bags (38) such as for picking up messes left by the pet as well as for treats (36) such as snacks or other training aids. The two pockets (22) shown here could be replaced by a variety of other hooks and loops and/or differently-shaped pockets or reservoirs. The neck (34) extends outwardly from the lid (14), but has a sealed cap (20) threadedly engaged with it in order to prevent leakage of the water out of the tote (10).

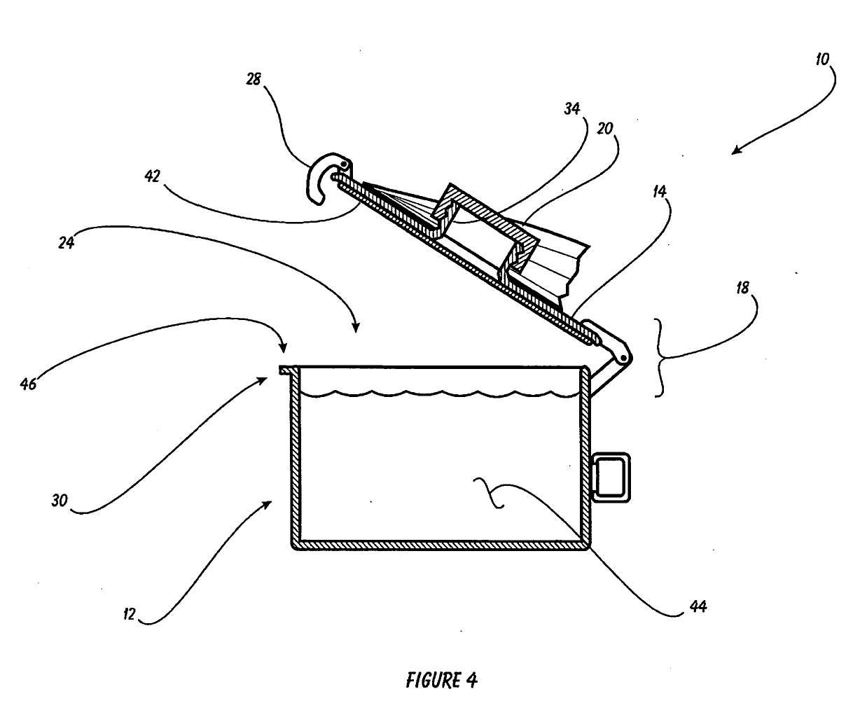

We will now turn to FIG. 4 to examine the tote from a different viewpoint. FIG. 4 is a partial cutaway side view of the tote of FIGS. 1 through 3. Shown here, the lid (14) has a neck (34) which creates fluid communication between the outside of the tote (10) and the reservoir (24). The reservoir (24) can either be filled with the lid open as shown or the cap (20) can be removed from the neck and water can be filled into the sealed reservoir (24). The body (12) is defined by a rim (46) that is smooth and particularly suited for watertight sealing with the gasket (42) that is attached to the inside surface of the lid (14). As can be appreciated, when the lid (14) is rotated about the hinge (18) until the gasket (42) engages the rim (46), the latch (28) can securely engage the latch tab (30) to create a sealed container that will not leak water.

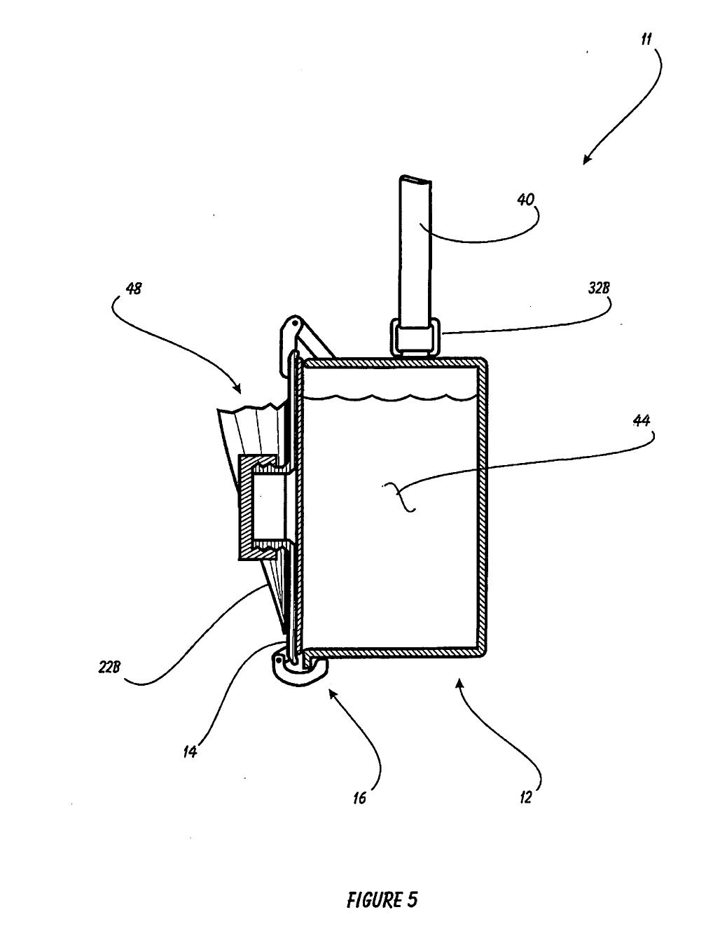

In FIG. 5 we can see the interior condition of the tote (10) when it's oriented in its transport position. FIG. 5 is a second partial cutaway side view of the tote of FIGS. 1 through 4. Here the water (44) would tend to be contained within the reservoir (24) without leaking past the gasket and rim (see FIG. 4). The pocket (22b) shown here will be oriented so the top opening (48) is at the top of the tote (10) to allow the easy insertion and removal of the various accessories while keeping them securely within while carrying the tote (10) with the shoulder strap (40) over the user's shoulder. Also shown here, the latch assembly (16) is securely engaged so that the watertight seal is secure. Not shown here, but potential options available would include a cloth cover for decorative and/or durability purposes for the tote. Also, the latch assembly (16) and cap (20) might be provided with locking devices to prevent third persons from tampering with the contents over the reservoir (24).

Those skilled in the art will appreciate that various adaptations and modifications of the just-described preferred embodiment can be configured without departing from the scope and spirit of the invention. Therefore, it is to be understood that within the scope of the appended claims, the invention may be practiced other than as specifically described herein.

What is claimed is:

1. A portable pet water bowl assembly, comprising:
a water bowl defining a bottom and a wall terminating in an upper edge, said water bowl defining a reservoir;
a lid engagable with said water bowl to create a water-tight seal against said upper edge, said lid cooperatively sized relative to said upper edge to be juxtaposed thereover to create said water-tight seal.

2. The assembly of claim 1, wherein said lid further comprises a fill throat extending upwardly therefrom, said fill throat defining a bore in fluid communication with said reservoir when said lid is sealed against said upper edge.

3. The assembly of claim 2, wherein said lid is further defined by an inner surface and an outer surface, said lid further comprising at least one pouch disposed on said outer surface.

4. The assembly of claim 3, further comprising a lid threadedly engaging said fill throat.

5. The assembly of claim 4, further comprising a latch for securing said lid to seal against said upper rim.

6. The assembly of claim 5, further comprising one or more strap loops disposed on an outer surface defined by said body.

7. The assembly of claim 6, further comprising an elongate strap attached to said one or more strap loops.

8. A portable canteen assembly comprising:
a body defining an internal chamber and an upper rim; and
a lid hingably attached to said body, said lid having an outer edge configured to seal against said upper rim when said lid is closed against said body, said lid farther defined by a fill throat disposed thereon to provide a path for liquid to enter said internal chamber when said lid is sealed against said upper rim.

9. The assembly of claim 8, wherein said lid is further defined by an inner surface and an outer surface, said lid further comprising at least one pouch disposed on said outer surface.

10. The assembly of claim 9, further comprising a lid threadedly engaging said fill throat.

11. The assembly of claim 10, further comprising a latch for securing said lid to seal against said upper rim.

12. The assembly of claim 11, further comprising one or more strap loops disposed on an outer surface defined by said body.

13. The assembly of claim 12, further comprising an elongate strap attached to said one or more strap loops.

14. A clamshell-shaped water reservoir, comprising:
a body defining an internal chamber formed by substantially vertical walls terminating in an upper rim; and
a lid hingably attached to said body, said lid having an outer edge configured to seal against said upper rim when said lid is closed against said body, said lid further defined by a fill throat disposed thereon to provide a path for liquid to enter said internal chamber when said lid is sealed against said upper rim.

15. The assembly of claim 14, further comprising a lid threadedly engaging said fill throat.

16. The assembly of claim 15, further comprising a latch for securing said lid to seal against said upper rim.

17. The assembly of claim 16, further comprising one or more strap loops disposed on an outer surface defined by said body.

18. The assembly of claim 17, further comprising an elongate strap attached to said one or more strap loops.

19. The assembly of claim 18, wherein said lid is further defined by an inner surface and an outer surface, said lid further comprising at least one pouch disposed on said outer surface.
